(19) United States
(12) Patent Application Publication
(10) Pub. No.: US 2025/0135783 A1
(43) Pub. Date: May 1, 2025

(54) LIQUID RECEIVING DEVICE AND LIQUID EJECTING DEVICE

(71) Applicant: SEIKO EPSON CORPORATION, TOKYO (JP)

(72) Inventors: Hiroyuki NAKAMURA, Shiojiri-shi (JP); Tomoyuki MIYAZAWA, MATSUMOTO-SHI (JP); Akihiro TOYA, Shiojiri-shi (JP); Yota TERAKAWA, SHIOJIRI-SHI (JP); Satoshi INOMATA, MATSUMOTO-SHI (JP)

(21) Appl. No.: 18/928,248

(22) Filed: Oct. 28, 2024

(30) Foreign Application Priority Data
Oct. 26, 2023 (JP) 2023-183798
Oct. 27, 2023 (JP) 2023-184502

(51) Int. Cl. B41J 2/165; B41J 2/14

(52) U.S. Cl. CPC B41J 2/16535; B41J 2/14; B41J 2/16523

(57) ABSTRACT

A liquid receiving device includes a receiving unit configured to receive a liquid from an ejecting unit configured to eject the liquid, and a joining member joined to the receiving unit, wherein the receiving unit includes a reception wall configured to receive the liquid, and a circumference wall extending from the reception wall, the circumference wall defines a reception port through which the liquid discharged from the ejecting unit passes, and includes a joining surface joined to the joining member, and the joining member extends along the circumference wall, and includes a protruding portion extending inward from the circumference wall.

The present application is based on, and claims priority from JP Application Serial Number 2023-184502, filed Oct. 27, 2023, and 2023-183798, filed Oct. 26, 2023, the disclosures of which are hereby incorporated by reference herein in its entirety.

### BACKGROUND

### 1. Technical Field

The present disclosure relates to a liquid receiving device and a liquid ejecting device.

### 2. Related Art

JP-A-2022-138289 describes a liquid ejecting device including an ejecting unit that ejects a liquid, and a receiving unit that receives the liquid from the ejecting unit. The receiving unit includes a reception wall that receives the liquid and a circumference wall extending from the reception wall.

In such a liquid ejecting device, the liquid may creep up the circumference wall due to a capillary force at a corner portion formed in the circumference wall. When this happens, the liquid might leak from the receiving unit.

### SUMMARY

A liquid receiving device to solve the problem described above includes a receiving unit configured to receive a liquid from an ejecting unit configured to eject the liquid, and a joining member joined to the receiving unit, wherein the receiving unit includes a reception wall configured to receive the liquid, and a circumference wall extending from the reception wall, the circumference wall defines a reception port through which the liquid discharged from the ejecting unit passes, and includes a joining surface joined to the joining member, and the joining member extends along the circumference wall, and includes a protruding portion extending inward from the circumference wall.

A liquid ejecting device to solve the problem described above includes an ejecting unit that includes a nozzle surface in which a nozzle opens and is configured to eject a liquid from the nozzle, and a wiping unit configured to wipe the nozzle surface, wherein the wiping unit includes a blade that comes into contact with the nozzle surface, a receiving unit configured to support the blade, and a joining member joined to the receiving unit, the receiving unit includes a reception wall configured to receive the liquid and a circumference wall extending from the reception wall, the circumference wall defines a reception port through which the liquid discharged from the ejecting unit passes, and includes a joining surface joined to the joining member, the blade extends in a protruding manner from the reception port, and the joining member extends along the circumference wall, and includes a protruding portion extending inward from the circumference wall.

### BRIEF DESCRIPTION OF THE DRAWINGS

FIG. 1 is a side view illustrating an example of a liquid ejecting device.

FIG. 2 is a bottom view illustrating a state where a wiping unit is located at a standby position.

FIG. 3 is a bottom view illustrating a state where the wiping unit is located at a start position.

FIG. 4 is a top view illustrating an example of a liquid receiving device.

FIG. 5 is a top view of a receiving unit.

FIG. 6 is a cross-sectional view of the liquid receiving device.

FIG. 7 is an enlarged view of FIG. 3.

FIG. 8 is a schematic view illustrating an example of the liquid ejecting device.

FIG. 9 is a graph illustrating a transition of measured pressure in an opening/closing inspection.

FIG. 10 is a flowchart illustrating an example of an opening inspection.

FIG. 11 is a flowchart illustrating an example of a closing inspection.

FIG. 12 is a graph illustrating a transition of measured pressure in a wiper inspection.

FIG. 13 is a graph illustrating a transition of the measured pressure in discharge processing.

FIG. 14 is a graph illustrating transition of measured pressure in a cause determination inspection.

### DESCRIPTION OF EMBODIMENTS

An example of a liquid ejecting device will be described below with reference to the drawings. The liquid ejecting device is, for example, an ink jet-type printer that performs printing of an image such as characters and photographs on a medium such as a sheet and fabric by ejecting ink, which is an example of liquid.

### Liquid Ejecting Device

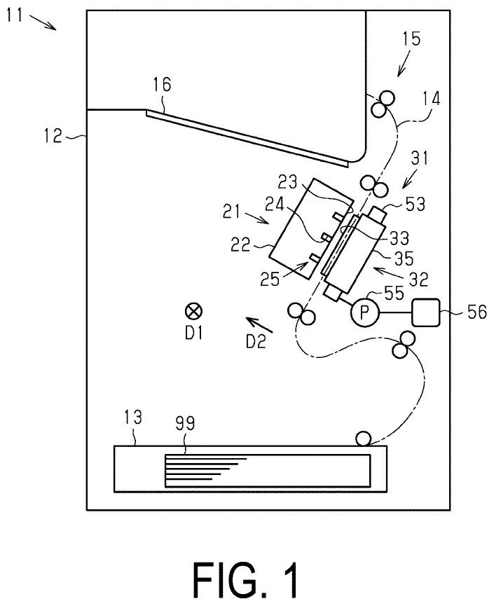

As illustrated in FIG. 1, a liquid ejecting device 11 includes a housing 12.

The liquid ejecting device 11 includes an accommodation unit 13. The accommodation unit 13 is configured to accommodate a medium 99. The accommodation unit 13 is a cassette drawable from the housing 12, for example. The accommodation unit 13 accommodates a plurality of the media 99 stacked.

The liquid ejecting device 11 includes a conveyance path 14. The conveyance path 14 is a path on which the medium 99 is conveyed. The conveyance path 14 extends inside the housing 12. For example, the conveyance path 14 extends so that the medium 99 is discharged from the accommodation unit 13 to the outside of the housing 12. An image is printed on the medium 99 while being conveyed on the conveyance path 14. The medium 99 is conveyed on the conveyance path 14, and then is discharged to the outside of the housing 12.

The liquid ejecting device 11 includes a conveyance unit 15. The conveyance unit 15 is configured to convey the medium 99. The conveyance unit 15 conveys the medium 99 accommodated in the accommodation unit 13, along the conveyance path 14. For example, the conveyance unit 15 includes one or more rollers. The rollers are located at positions along the conveyance path 14.

The liquid ejecting device 11 includes a stacker 16. On the stacker 16, the media 99 on which an image is printed are stacked. The stacker 16 is attached to the housing 12. The stacker 16 receives the medium 99 discharged to the outside of the housing 12 through the conveyance path 14.

The liquid ejecting device 11 includes an ejecting unit 21. The ejecting unit 21 is configured to eject a liquid. The image is printed on the medium 99, with the liquid ejected from the ejecting unit 21 onto the medium 99. The ejecting unit 21 is located at a position along the conveyance path 14. The ejecting unit 21 ejects the liquid onto the medium 99 conveyed on the conveyance path 14.

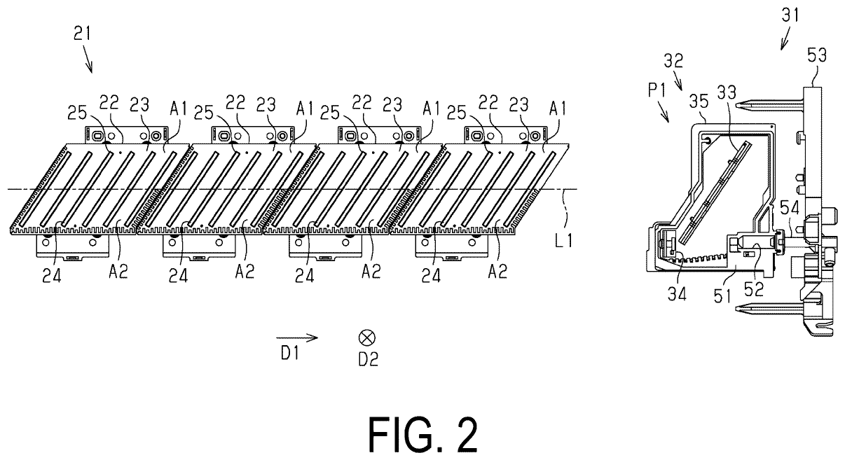

As illustrated in FIG. 2, the ejecting unit 21 includes one or more heads 22. In one example, the ejecting unit 21 includes a plurality of the heads 22. For example, the plurality of heads 22 are arranged in one direction. In one example, the plurality of heads 22 are arranged in a scanning direction D1. With the plurality of heads 22 arranged in the scanning direction D1, the ejecting unit 21 can eject the liquid over the entire width of the media 99. In one example, the ejecting unit 21 is a line head capable of ejecting the liquid simultaneously over the entire width of the medium 99. The ejecting unit 21 may be a serial head that ejects the liquid while moving in the scanning direction D1 relative to the medium 99.

The head 22 includes a nozzle surface 23. One or more nozzles 24 open in the nozzle surface 23. In one example, a plurality of the nozzles 24 open in the nozzle surface 23. A plurality of nozzle arrays 25 are formed in the nozzle surface 23. The nozzle array 25 is an arrayed formed with the plurality of nozzles 24 arranged in one direction. On the nozzle surface 23, the plurality of nozzle arrays 25 are arranged in the scanning direction D1. The nozzle arrays 25 extend in a direction different from the scanning direction D1. Specifically, the plurality of nozzles 24 forming one nozzle array 25 are arranged in a direction different from the scanning direction D1.

The head 22 ejects the liquid from the nozzles 24. In one example, the head 22 ejects the liquid from the nozzles 24 in a direction in which the nozzle surface 23 is inclined with respect to the horizontal direction and the vertical direction. Specifically, the nozzle surface 23 is oriented obliquely downward.

The nozzle surface 23 includes an upper region A1 and a lower region A2. The upper region A1 and the lower region A2 are regions obtained by dividing the nozzle surface 23 into two by a virtual line L1 extending in the scanning direction D1, as viewed from a position facing the nozzle surface 23. The upper region A1 is located above the lower region A2. The nozzle array 25 is located over each of the upper region A1 and the lower region A2. The virtual line L1 extends to cross the nozzle array 25.

The ejecting unit 21 may be configured to move in a direction perpendicular to the nozzle surface 23. By moving in this direction, the ejecting unit 21 moves toward and away from a maintenance unit 31 described below. The ejecting unit 21 can come into contact with the maintenance unit 31 by moving toward the maintenance unit 31.

### Maintenance Unit

As illustrated in FIG. 1, the liquid ejecting device 11 includes the maintenance unit 31. The maintenance unit 31 is configured to perform maintenance for the ejecting unit 21. For example, the maintenance unit 31 performs the maintenance for the ejecting unit 21 by receiving the liquid discharged from the ejecting unit 21 in cleaning. The cleaning is an operation of forcibly discharging a liquid from the nozzles 24. A thickened liquid, air bubbles, or the like is discharged from the ejecting unit 21 in the cleaning.

The cleaning includes pressurized cleaning. The pressurized cleaning is an operation of pressurizing the inside of the ejecting unit 21 to forcibly discharge the liquid from the nozzles 24. In one example, the pressurized cleaning is performed with a pressurizing pump (not illustrated) pressurizing the inside of the ejecting unit 21.

The cleaning includes suction cleaning. The suction cleaning is an operation of performing suction inside the ejecting unit 21 to forcibly discharge the liquid from the nozzles 24. In one example, the suction cleaning is performed with the maintenance unit 31 performing the suction the inside of the ejecting unit 21.

The maintenance unit 31 may perform the maintenance for the ejecting unit 21 by receiving the liquid ejected by the ejecting unit 21 in flushing. The flushing is a maintenance performed with the ejecting unit 21 appropriately ejecting a liquid from the nozzles 24. Clogging of the nozzles 24 can be suppressed by the flushing. The maintenance unit 31 may include a flushing receiver that receives the liquid ejected from the ejecting unit 21 in the flushing.

The maintenance unit 31 may perform the maintenance for the ejecting unit 21, by capping the ejecting unit 21. The capping is an operation of forming a space in communication with the nozzles 24 by bringing the maintenance unit 31 in contact with the ejecting unit 21. The nozzles 24 are kept moisturized by the capping. The maintenance unit 31 may include a cap 122 for capping the ejecting unit 21. The cap 122 may receive the liquid discharged from the ejecting unit 21 in the cleaning, for example. The cap 122 may also receive the liquid ejected from the ejecting unit 21 in the flushing.

The maintenance unit 31 performs the maintenance for the ejecting unit 21, by wiping the ejecting unit 21. The wiping is an operation of wiping the nozzle surface 23 by the maintenance unit 31. The liquid, a foreign substance, and the like are removed from the nozzle surface 23 by the wiping.

The maintenance unit 31 includes a wiping unit 32. The wiping unit 32 is configured to wipe the nozzle surface 23. Specifically, the wiping unit 32 is configured to wipe the ejecting unit 21.

The wiping unit 32 may be configured to move in a direction perpendicular to the nozzle surface 23. By moving in this direction, the wiping unit 32 moves toward and away from the ejecting unit 21. The wiping unit 32 can come into contact with the nozzle surface 23 by coming into contact with the ejecting unit 21.

The wiping unit 32 is configured to move in the scanning direction D1. Specifically, the wiping unit 32 is configured to move in the scanning direction D1 and in a direction opposite thereto. The wiping unit 32 wipes the ejecting unit 21 by moving in the scanning direction D1 while being in contact with the nozzle surface 23. The wiping unit 32 may wipe the ejecting unit 21 with the ejecting unit 21 moving in the scanning direction D1 relative to the wiping unit 32.

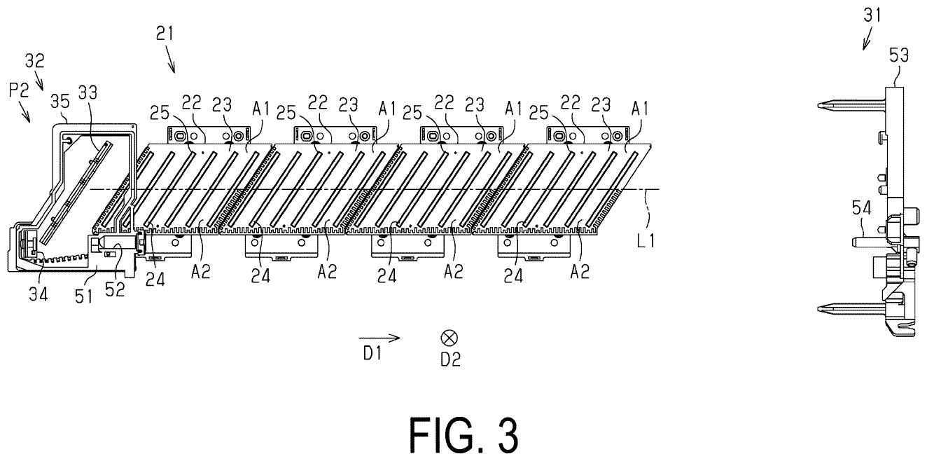

As illustrated in FIG. 2 and FIG. 3, the wiping unit 32 moves in the scanning direction D1 between a standby position P1 and a start position P2. The standby position P1 is a position at which the wiping unit 32 stands by. For example, the wiping unit 32 stands by at the standby position P1, when the ejecting unit 21 is not wiped. In one example, the standby position P1 is a position shifted from the start position P2 in the scanning direction D1. The start position P2 is a position at which the wiping unit 32 starts the wiping. When starting the wiping, the wiping unit 32 moves from the standby position P1 to the start position P2. The wiping unit 32 wipes the ejecting unit 21 by moving from the start position P2. In one example, the wiping unit 32 wipes the ejecting unit 21 by moving from the start position P2 in the scanning direction D1.

The wiping unit 32 includes a blade 33. The blade 33 comes into contact with the nozzle surface 23. The blade 33 wipes the nozzle surface 23. The blade 33 is, for example, a rubber wiper. The blade 33 extends parallel to the nozzle array 25. As the wiping unit 32 moves in the scanning direction D1, the blade 33 sequentially wipes the plurality of heads 22.

The wiping unit 32 may include a sub-blade 34. The sub-blade 34 comes into contact with a side surface of the head 22. The sub-blade 34 wipes the side surface of the head 22. In one example, the sub-blade 34 comes into contact with a side surface facing downward among a plurality of side surfaces of the head 22. This is because the liquid is likely to flow from the nozzle surface 23 to the side surface facing downward due to gravity.

The wiping unit 32 includes a liquid receiving device 35. The liquid receiving device 35 is configured to receive a liquid from the ejecting unit 21. The liquid receiving device 35 stores the liquid received from the ejecting unit 21. In one example, the liquid receiving device 35 receives the liquid wiped off by the blade 33. The liquid receiving device 35 receives the liquid flowing down the blade 33. The liquid receiving device 35 receives the liquid wiped off by the sub-blade 34. The liquid receiving device 35 receives the liquid flowing down the sub-blade 34.

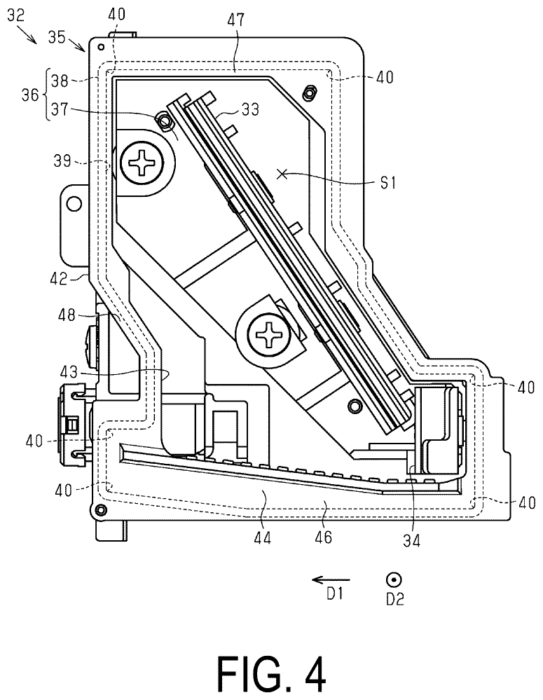

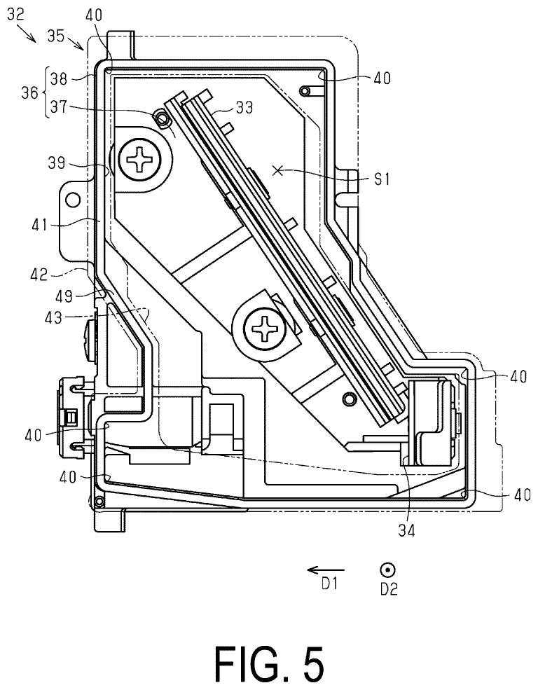

As illustrated in FIG. 4 and FIG. 5, the liquid receiving device 35 includes a receiving unit 36. The receiving unit 36 is configured to receive the liquid from the ejecting unit 21. The receiving unit 36 supports the blade 33. The receiving unit 36 supports the sub-blade 34.

The receiving unit 36 includes a reception wall 37. The reception wall 37 is a wall that receives a liquid. The reception wall 37 forms a bottom wall of the receiving unit 36. The blade 33 is attached to the reception wall 37. The blade 33 extends perpendicularly from the reception wall 37. The sub-blade 34 is attached to the reception wall 37. The sub-blade 34 extends perpendicularly from the reception wall 37.

The receiving unit 36 includes a circumference wall 38. The circumference wall 38 extends from the reception wall 37. Specifically, the circumference wall 38 perpendicularly extends from the reception wall 37. In one example, the circumference wall 38 extends from a circumference edge of the reception wall 37. The circumference wall 38 forms a side wall of the receiving unit 36. The circumference wall 38 extends to surround the blade 33. The circumference wall 38 extends to surround the sub-blade 34.

A reception port 39 through which the liquid discharged from the ejecting unit 21 passes opens in the receiving unit 36. The reception port 39 is defined by the circumference wall 38. The reception port 39 faces the ejecting unit 21. The reception port 39 faces the nozzle surface 23. In one example, the reception port 39 opens in an inclined direction D2. The inclined direction D2 is a direction inclined with respect to the horizontal direction and the vertical direction. The inclined direction D2 is a direction perpendicular to the nozzle surface 23. The blade 33 and the sub-blade 34 extend so as to protrude from the reception port 39.

The circumference wall 38 annularly extends on the reception wall 37. Thus, an accommodation space S1 is formed in the receiving unit 36. The accommodation space S1 is a space in which the liquid is accommodated. The accommodation space S1 communicates with the reception port 39. The liquid enters the accommodation space S1 through the reception port 39. Annular refers to any structure that forms a loop, that is, an endless continuous shape. The annular shape includes, but is not limited to, circle, ellipse, and polygon with pointed or rounded corners.

The circumference wall 38 extends while being bent on the reception wall 37. Thus, the circumference wall 38 forms corner portions 40. In one example, the circumference wall 38 extends to be in a polygonal shape as viewed from a position facing the reception port 39. The corner portions 40 serve as corners of the accommodation space S1. The liquid may spread along the corner portions 40 due to a capillary force. Thus, in the corner portion 40, the liquid may creep up the circumference wall 38 toward the reception port 39. If the liquid flows over the circumference wall 38, the liquid may leak out from the receiving unit 36. In the liquid receiving device 35, the risk of overflowing from the circumference wall 38 is reduced by a joining member 42 described below.

The circumference wall 38 includes a joining surface 41. The joining surface 41 is a surface joined to the joining member 42. The joining surface 41 forms a top surface of the circumference wall 38. The joining surface 41 faces the nozzle surface 23. In one example, the joining surface 41 is oriented in the inclined direction D2.

The liquid receiving device 35 includes the joining member 42. The joining member 42 is joined to the receiving unit 36. Specifically, the joining member 42 is joined to the circumference wall 38. In one example, the joining member 42 is joined to the joining surface 41. Thus, the joining member 42 is located on the circumference wall 38. The joining member 42 is located on the joining surface 41.

The joining member 42 is joined to the receiving unit 36 by being welded to the receiving unit 36. In one example, the joining member 42 is laser welded to the receiving unit 36. The joining member 42 may be thermally welded or ultrasonically welded to the receiving unit 36. The joining member 42 may be joined to the receiving unit 36 by an adhesive, and thus the welding should not be construed in a limiting sense.

The joining member 42 is joined to the receiving unit 36 by emitting a laser beam onto the joining surface 41 in contact with the joining member 42. A portion of the joining member 42 that is in contact with the joining surface 41 is made of, for example, a material that transmits the laser beam. In one example, the entire joining member 42 is made of a material that transmits the laser beam. The joining surface 41 is made of, for example, a material that absorbs the laser beam. When the joining surface 41 is melted by the laser beam, the joining member 42 is welded to the receiving unit 36. In one example, the entire circumference wall 38 is made of a material that absorbs the laser beam. The entire receiving unit 36 may be made of a material that absorbs the laser beam.

A portion of the joining member 42 that comes into contact with the joining surface 41 may be made of a material that is the same as the material of the joining surface 41. In one example, the entire joining member 42 is made of the same material as the circumference wall 38. The joining member 42 may be made of the same resin material as the circumference wall 38. The joining member 42 and the circumference wall 38 may be made of, for example, polypropylene. When the joining member 42 and the circumference wall 38 are made of the same material, the joining strength between the joining member 42 and the receiving unit 36 is improved.

The joining member 42 extends along the circumference wall 38. Thus, the joining member 42 extends annularly.

A joint port 43 opens in the joining member 42. The joint port 43 communicates with the reception port 39. The receiving unit 36 receives the liquid through the joint port 43. The joint port 43 opens so as to be slightly smaller than the reception port 39. Specifically, the joining member 42 overlaps the circumference edge of the reception port 39 as viewed from a position facing the reception port 39. As viewed from a position facing the reception port 39, in the reception port 39, an area of a portion overlapping the joining member 42 is smaller than an area not overlapping the joining member 42. With such a configuration, since the joint port 43 is largely open, evaporation of the liquid stored in the receiving unit 36 is facilitated.

The joining member 42 has a protruding portion 44. The protruding portion 44 extends inward from the circumference wall 38. Specifically, the protruding portion 44 extends inward from the circumference wall 38 as viewed from a position facing the reception port 39. The protruding portion 44 extends inward from the entire circumference of the joining surface 41. The protruding portion 44 may extend with a uniform length over the entire circumference of the circumference wall 38, or may extend with the length differing among positions of the circumference wall 38. The protruding portion 44 makes the joint port 43 slightly smaller than the reception port 39. The protruding portion 44 blocks the liquid that creeps up the circumference wall 38. This reduces the possibility that the liquid creeping up the circumference wall 38 leaks to the outside of the receiving unit 36. In addition, with the protruding portion 44, even when the reception port 39 opens in the inclined direction D2, the receiving unit 36 can accommodate the liquid.

A portion of the protruding portion 44 corresponding to the corner portion 40 may extend inward from the circumference wall 38 by a greater distance than other portions. In this case, a possibility of the leakage of the liquid is further reduced.

The distance by which the protruding portion 44 extends inward from the circumference wall 38 may be long enough to prevent the product of the joining from reaching the joint port 43. For example, when the joining member 42 is welded to the receiving unit 36, the length may be set to be long enough for preventing the molten material of the circumference wall 38 from reaching the joint port 43. When the joining member 42 is joined to the receiving unit 36, the length is preferably set to be long enough to prevent the adhesive applied to the joining surface 41 from reaching the joint port 43.

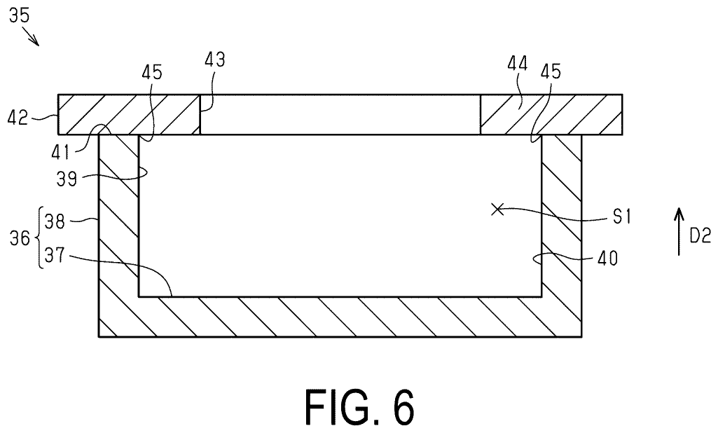

As illustrated in FIG. 6, the joining member 42 forms a boundary portion 45. The boundary portion 45 is a portion serving as a boundary between the joining member 42 and the circumference wall 38 in the accommodation space S1. The boundary portion 45 is continuous with the corner portion 40. In the boundary portion 45, as in the corner portion 40, the liquid is likely to spread due to the capillary force. Therefore, the liquid may spread along the boundary portion 45 by creeping up the circumference wall 38 at the corner portion 40. In view of this, the joining member 42 is welded over the entire circumference of the circumference wall 38. Therefore, the boundary portion 45 extends annularly. In this case, even if the liquid spreads along the boundary portion 45, the liquid would no creep up the protruding portion 44 toward the joint port 43. Thus, the possibility of leakage of the liquid to the outside of the receiving unit 36 is reduced.

As illustrated in FIG. 4, the protruding portion 44 includes a first portion 46 and a second portion 47. The first portion 46 is a portion of the protruding portion 44 that protrudes upward from the circumference wall 38. The second portion 47 is a portion protruding downward from the circumference wall 38. The first portion 46 is a portion of the protruding portion 44 located on the lower side. The second portion 47 is a portion of the protruding portion 44 located on the upper side. In one example, the first portion 46 is longer than the second portion 47. Thus, when the reception port 39 opens in the inclined direction D2, accumulation of the liquid is facilitated by the first portion 46 and the circumference wall 38.

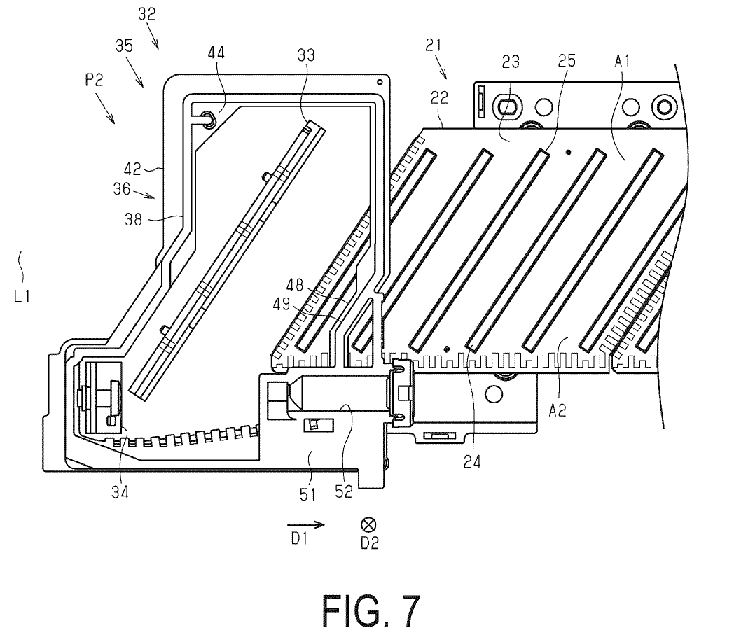

As illustrated in FIG. 7, the joining member 42 includes an extending portion 48. The extending portion 48 is a portion that extends between the nozzle arrays 25 when the wiping unit 32 is positioned at the start position P2. Specifically, as viewed in the inclined direction D2, at the start position P2, the extending portion 48 extends between the nozzle arrays 25. More specifically, the extending portion 48 extends so as to pass through a portion located in the lower region A2 between the nozzle arrays 25. The extending portion 48 extends parallel to the nozzle array 25. Thus, the possibility of the liquid adhering to the joining member 42 at the start position P2 is reduced. The circumference wall 38 has a circumventing portion 49 extending to pass between the nozzle arrays 25 in accordance with the extending portion 48. The circumventing portion 49 extends in parallel with the nozzle array 25.

As viewed in the inclined direction D2, the wiping unit 32 overlaps the nozzle surface 23 at the start position P2. In one example, as viewed in the inclined direction D2, the receiving unit 36 and the joining member 42 overlap the nozzle surface 23 at the start position P2. Thus, the moving distance in the scanning direction D1 required for wiping is reduced. On the other hand, the wiping unit 32 and the nozzle surface 23 overlapping at the start position P2 involves a risk that the liquid may adhere to the joining member 42. In particular, since the nozzle surface 23 is inclined, the liquid is likely to be accumulated in a portion of the nozzle array 25 located in the lower region A2. Therefore, if the portion of the joining member 42 overlapping the nozzle array 25 located in the lower region A2 is large, there is a high risk of the liquid adhering to the joining member 42. In view of this, the extending portion 48 reduces the portion of the joining member 42 overlapping the nozzle array 25 positioned in the lower region A2, whereby the risk of the liquid adhering to the joining member 42 is reduced.

The liquid receiving device 35 may include a lead-out portion 51. The lead-out portion 51 is configured to lead the liquid out from the receiving unit 36. The lead-out portion 51 is attached to the receiving unit 36. The lead-out portion 51 is located in a lower portion of the receiving unit 36. For example, the lead-out portion 51 is positioned so as to overlap the first portion 46 as viewed from a position facing the reception port 39. The lead-out portion 51 is positioned in the lower portion of the receiving unit 36, so that the liquid can be led out easily. The lead-out portion 51 is configured to be connected to, for example, a connection portion 53 to be described below. The lead-out portion 51 communicates with the inside of the receiving unit 36, that is, the accommodation space S1. An insertion port 52 is open in the lead-out portion 51. For example, the insertion port 52 is open in the scanning direction D1. The lead-out portion 51 is connected to the connection portion 53, with the connection portion 53 inserted in the insertion port 52.

As illustrated in FIG. 2 and FIG. 3, the maintenance unit 31 includes the connection portion 53. The connection portion 53 is configured to be connected to the liquid receiving device 35. Specifically, the connection portion 53 is connected to the lead-out portion 51. The connection portion 53 is connected to the lead-out portion 51 when the wiping unit 32 is located at a predetermined position. In one example, the connection portion 53 is connected to the lead-out portion 51 when the wiping unit 32 is positioned at the standby position P1. The connection portion 53 is located at a position shifted from the ejecting unit 21 in the scanning direction D1.

The connection portion 53 includes a connection needle 54. The connection needle 54 extends toward the wiping unit 32. In one example, the connection needle 54 extends in a direction opposite to the scanning direction D1. The connection needle 54 is inserted into the insertion port 52. In one example, the connection needle 54 is inserted into the insertion port 52 when the wiping unit 32 moves in the scanning direction D1. Thus, the liquid can be led out from the receiving unit 36.

As illustrated in FIG. 1, the maintenance unit 31 includes a suction unit 55. The suction unit 55 includes, for example, a suction pump. The suction unit 55 is connected to the connection portion 53. The suction unit 55 is configured to suck the liquid inside the receiving unit 36 through the connection portion 53. With the suction unit 55, the liquid is effectively led out from the receiving unit 36.

The maintenance unit 31 may include a waste liquid accommodation unit 56. The waste liquid accommodation unit 56 is connected to the suction unit 55. The waste liquid accommodation unit 56 accommodates the liquid sucked from the receiving unit 36 by the suction unit 55. Thus, the waste liquid accommodation unit 56 accommodates the liquid collected from the ejecting unit 21 as a result of the maintenance.

### Liquid Ejecting Device

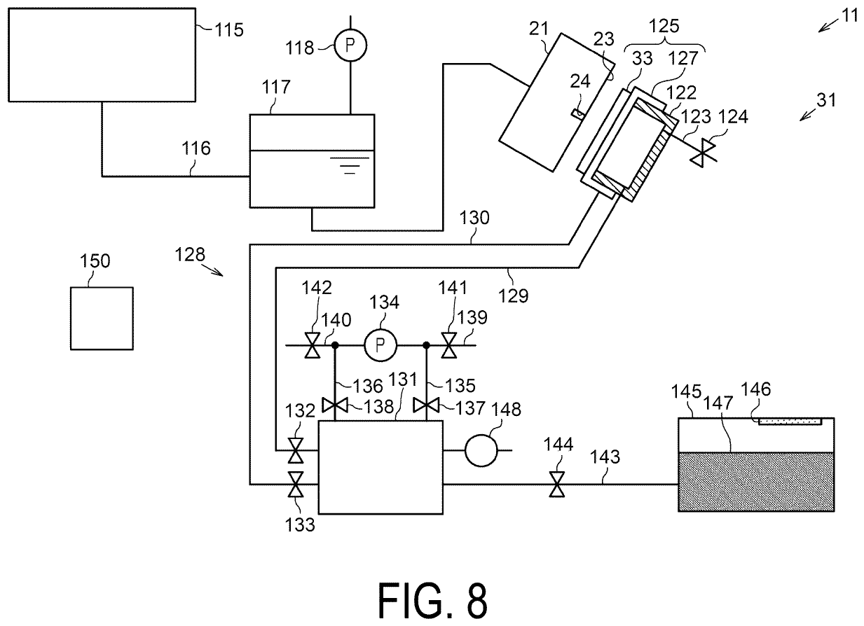

As illustrated in FIG. 8, the liquid ejecting device 11 includes the ejecting unit 21. The ejecting unit 21 is configured to eject a liquid. The image is printed on the medium, with the liquid ejected from the ejecting unit 21 onto the medium 99.

The ejecting unit 21 includes the nozzle surface 23. One or more nozzles 24 open in the nozzle surface 23. The ejecting unit 21 ejects the liquid from the nozzle 24. In one example, the ejecting unit 21 ejects the liquid in an inclined orientation with which the nozzle surface 23 is inclined with respect to the horizontal direction. The ejecting unit 21 is a line head that can eject the liquid simultaneously over the width of the medium 99. The ejecting unit 21 may be a serial head that ejects the liquid while scanning the medium 99.

The ejecting unit 21 may be configured to move in a direction perpendicular to the nozzle surface 23. By moving in this direction, the ejecting unit 21 moves toward and away from the maintenance unit 31 described below. The ejecting unit 21 can come into contact with the maintenance unit 31 by moving toward the maintenance unit 31.

The liquid ejecting device 11 is configured in such a manner that a liquid container 115 is attachable and detachable thereto and therefrom. The liquid container 115 stores the liquid. The liquid container 115 is, for example, an ink cartridge. When the liquid container 115 is attached to the liquid ejecting device 11, the liquid can be supplied to the ejecting unit 21 from the liquid container 115.

The liquid ejecting device 11 includes a connection flow path 116. The connection flow path 116 is connected to the ejecting unit 21 and the liquid container 115. A liquid is supplied from the liquid container 115 to the ejecting unit 21 through the connection flow path 116.

The liquid ejecting device 11 may include one or more sub tanks 117. The sub tank 117 stores a liquid. The sub tank 117 is located on the connection flow path 116. The sub tank 117 stores the liquid supplied from the liquid container 115. The liquid ejecting device 11 may be configured to make the liquid circulate between the sub tank 117 and the ejecting unit 21. The liquid ejecting device 11 may include, for example, a return flow path through which the liquid returns to the sub tank 117 from the ejecting unit 21.

The liquid ejecting device 11 includes a pressurizing unit 118. The pressurizing unit 118 is configured to pressurize the inside the ejecting unit 21. The pressurizing unit 118 is connected to, for example, the sub tank 117. The pressurizing unit 118 includes, for example, a pump. In this case, the pressurizing unit 118 pressurizes the inside of the ejecting unit 21 by sending air into the sub tank 117. With the pressurizing unit 118 pressurizing the inside the ejecting unit 21, the cleaning for the ejecting unit 21 is performed. The cleaning will be described below. The liquid may be circulated as a result of the pressurizing unit 118 pressurizing the inside of the ejecting unit 21. The pressurizing unit 118 may be a liquid pump located on the connection flow path 116.

The liquid ejecting device 11 includes the maintenance unit 31. The maintenance unit 31 is configured to perform maintenance for the ejecting unit 21. For example, the maintenance unit 31 performs the maintenance for the ejecting unit 21 by receiving the liquid discharged from the ejecting unit 21 in cleaning. The cleaning is an operation of forcibly discharging a liquid from the nozzles 24. A thickened liquid, air bubbles, or the like is discharged from the ejecting unit 21 in the cleaning.

The cleaning includes pressurized cleaning. The pressurized cleaning is an operation of pressurizing the inside of the ejecting unit 21 to forcibly discharge the liquid from the nozzles 24. In one example, the pressurized cleaning is performed with the pressurizing unit 118 pressurizing the inside of the ejecting unit 21.

The cleaning includes suction cleaning. The suction cleaning is an operation of performing suction inside the ejecting unit 21 to forcibly discharge the liquid from the nozzles 24. In one example, the suction cleaning is performed with the maintenance unit 31 performing the suction the inside of the ejecting unit 21.

The cleaning may include micro-pressure cleaning. Like the pressurized cleaning, the micro-pressure cleaning is an operation of pressurizing the inside of the ejecting unit 21 to forcibly discharge the liquid from the nozzles 24. In one example, the micro-pressure cleaning is performed with the pressurizing unit 118 pressurizing the inside of the ejecting unit 21. The amount of liquid discharged from the nozzles 24 during the micro-pressure cleaning is smaller than that during the pressurized cleaning. Therefore, the cleaning level of the micro-pressure cleaning is lower than that of the pressurized cleaning.

The cleaning may include circulation cleaning. The circulation cleaning is an operation of making the liquid circulate by pressurizing the inside of the ejecting unit 21, as in the case of the pressurized cleaning and the micro-pressure cleaning. With the circulation cleaning, the liquid may leak from the nozzles 24 as a result of the pressurization inside the ejecting unit 21. Thus, the circulation cleaning is an operation of forcibly discharging a liquid from the nozzles 24.

The maintenance unit 31 may perform the maintenance for the ejecting unit 21 by receiving the liquid ejected by the ejecting unit 21 in flushing. The flushing is a maintenance performed with the ejecting unit 21 appropriately ejecting a liquid from the nozzles 24. Clogging of the nozzles 24 can be suppressed by the flushing.

The maintenance unit 31 may perform the maintenance for the ejecting unit 21, by wiping the ejecting unit 21. The wiping is an operation of wiping the nozzle surface 23 by the maintenance unit 31. The liquid, a foreign substance, and the like are removed from the nozzle surface 23 by the wiping.

The maintenance unit 31 may perform the maintenance for the ejecting unit 21, by capping the ejecting unit 21. The capping is an operation of forming a space in communication with the nozzles 24 by bringing the maintenance unit 31 in contact with the ejecting unit 21. The nozzles 24 are kept moisturized by the capping.

The maintenance unit 31 includes the cap 122. The cap 122 covers the nozzle 24 by coming into contact with the nozzle surface 23. Thus, the capping is implemented with the cap 122. The cap 122 not only implements the capping but also receives the liquid as a result of the cleaning and the flushing for the maintenance of the ejecting unit 21. The liquid received as a result of the cleaning and the flushing is collected in the cap 122.

The cap 122 may be configured to move in a direction perpendicular to the nozzle surface 23. By moving in this direction, the cap 122 moves toward and away from the ejecting unit 21. The cap 122 can come into contact with the ejecting unit 21 by coming into contact with the ejecting unit 21.

The maintenance unit 31 includes an atmospheric release path 123. The atmospheric release path 123 is connected to the cap 122. The atmospheric release path 123 is a flow path through which the inside of the cap 122 communicates with the atmosphere. The atmospheric release path 123 reduces a risk of the pressure inside the cap 122 being high during the capping for example. When the pressure in the cap 122 becomes high due to, for example, a rise in temperature during capping or the like, a meniscus formed in the nozzle 24 may be broken. The atmospheric release path 123 may include a thin tube. In this case, the atmospheric release path 123 has a large flow path resistance. Thus, the pressure in the cap 122 can be released through the atmospheric release path 123, and the vapor is less likely to be discharged from the inside of the cap 122, whereby the moisture retention capacity of the cap 122 is improved.

The maintenance unit 31 includes an atmospheric relief valve 124. The atmospheric relief valve 124 is located on the atmospheric release path 123. The atmospheric relief valve 124 opens and closes the atmospheric release path 123. When the atmospheric relief valve 124 is open, the inside of the cap 122 communicates with the atmosphere through the atmospheric release path 123. The atmospheric relief valve 124 is a solenoid valve for example.

The maintenance unit 31 may include a wiper 125. The wiper 125 comes into contact with the nozzle surface 23 to wipe the nozzle surface 23. Thus, the wiper 125 executes the wiping.

The wiper 125 includes the blade 33 that comes into contact with the nozzle surface 23 and a holder 127 that holds the blade 33. The wiper 125 wipes the nozzle surface 23 by moving in a longitudinal direction of the ejecting unit 21 while being in contact with the nozzle surface 23. The nozzle surface 23 may be wiped with the ejecting unit 21 moving relative to the wiper 125. The liquid wiped as a result of the wiping is accumulated in the wiper 125. Specifically, the liquid flows from the nozzle surface 23 along the blade 33 and is accumulated in the holder 127.

The wiper 125 may be configured to move in a direction perpendicular to the nozzle surface 23. By moving in this direction, the wiper 125 moves toward and away from the ejecting unit 21. The wiper 125 can come into contact with the ejecting unit 21 by coming into contact with the ejecting unit 21.

The maintenance unit 31 includes a depressurizing unit 128. The depressurizing unit 128 is configured to depressurize the inside of the cap 122. The depressurizing unit 128 is connected to the cap 122. In one example, the depressurizing unit 128 is configured to depressurize not only the cap 122 but also the wiper 125. The depressurizing unit 128 is connected to the wiper 125.

The depressurizing unit 128 includes one or more depressurization paths. In one example, the depressurizing unit 128 includes two depressurization paths. Specifically, the depressurizing unit 128 includes a cap depressurization path 129 and a wiper depressurization path 130. The depressurization path is a flow path on which a negative pressure acts. The cap depressurization path 129 is connected to the cap 122. The inside of the cap 122 is depressurized through the cap depressurization path 129. The wiper depressurization path 130 is connected to the wiper 125. Specifically, the wiper depressurization path 130 is connected to the holder 127. The inside of the holder 127 is depressurized through the wiper depressurization path 130.

The depressurizing unit 128 includes a buffer 131. The buffer 131 is connected to the depressurization paths. In one example, the buffer 131 is connected to the cap depressurization path 129 and the wiper depressurization path 130. The pressure in the buffer 131 acts on the inside of the cap 122 through the cap depressurization path 129. The pressure of the buffer 131 acts on the wiper 125 through the wiper depressurization path 130. Specifically, the pressure of the buffer 131 acts on the inside of the holder 127 through the wiper depressurization path 130.

The buffer 131 stores the liquid collected from the ejecting unit 21 through the depressurization paths. The buffer 131 stores the liquid received by the cap 122, through the cap depressurization path 129. The buffer 131 stores the liquid wiped off by the wiper 125, through the wiper depressurization path 130.

The depressurizing unit 128 includes one or more on-off valves. In one example, the depressurizing unit 128 includes two on-off valves. Specifically, the depressurizing unit 128 includes a cap on-off valve 132 and a wiper on-off valve 133. The on-off valves are located on the depressurization paths. The on-off valve opens and closes the depressurization path. The cap on-off valve 132 is located on the cap depressurization path 129. The cap on-off valve 132 opens and closes the cap depressurization path 129. When the cap on-off valve 132 is open, the cap 122 and the buffer 131 communicate with each other through the cap depressurization path 129. The wiper on-off valve 133 is located on the wiper depressurization path 130. The wiper on-off valve 133 opens and closes the wiper depressurization path 130. When the wiper on-off valve 133 is open, the wiper 125 and the buffer 131 communicate with each other through the wiper depressurization path 130.

The depressurizing unit 128 includes a depressurizing pump 134. The depressurizing pump 134 is configured to depressurize the inside of the cap 122. In one example, the depressurizing pump 134 is connected to the buffer 131. The depressurizing pump 134 depressurizes the inside of the cap 122 by depressurizing the inside of the buffer 131. The depressurizing pump 134 depressurizes the inside of the cap 122 through the buffer 131 and the cap depressurization path 129. The depressurizing pump 134 may be directly connected to the cap 122 or may be directly connected to the cap depressurization path 129. The depressurizing pump 134 is, for example, an air pump.

The depressurizing unit 128 executes the suction cleaning by depressurizing the inside of the cap 122 using the depressurizing pump 134. Specifically, the depressurizing unit 128 executes the suction cleaning with the depressurizing pump 134 depressurizing the inside of the cap 122 in a state where the cap 122 is in contact with the nozzle surface 23 and the atmospheric relief valve 124 is closed. In a state where the cap 122 is in contact with the nozzle surface 23 and the atmospheric relief valve 124 is closed, the inside of the cap 122 does not communicate with the atmosphere. Therefore, when the depressurizing pump 134 depressurizes the inside of the cap 122, the negative pressure in the cap 122 acts on the nozzle 24. As a result, the liquid is discharged from the nozzles 24. In one example, in the suction cleaning, first, the depressurizing unit 128 depressurizes the inside of the buffer 131 using the depressurizing pump 134 in a state where the cap on-off valve 132 is closed. Next, the depressurizing unit 128 opens the cap on-off valve 132. As a result, the negative pressure in the buffer 131 acts on the inside of the cap 122. In this way, the depressurizing unit 128 executes the suction cleaning.

The depressurizing unit 128 executes idle suction by depressurizing the inside of the cap 122 using the depressurizing pump 134. Specifically, the depressurizing unit 128 executes the idle suction with the depressurizing pump 134 depressurizing the inside of the cap 122 in a state where the cap 122 is in contact with the nozzle surface 23 and the atmospheric relief valve 124 is open. The idle suction is an operation of discharging the liquid from the cap 122. In a state where the cap 122 is in contact with the nozzle surface 23 and the atmospheric relief valve 124 is open, the inside of the cap 122 communicates with the atmosphere through the atmospheric release path 123. Therefore, when the depressurizing pump 134 depressurizes the inside of the cap 122, the atmospheric air is drawn into the cap 122 through the atmospheric release path 123. As a result, the liquid is discharged from the cap 122. In one example, in the idle suction, first, the depressurizing unit 128 depressurizes the inside of the buffer 131 using the depressurizing pump 134 in a state where the cap on-off valve 132 is closed. Next, the depressurizing unit 128 opens the cap on-off valve 132. As a result, the negative pressure in the buffer 131 acts on the inside of the cap 122. In this way, the depressurizing unit 128 executes the idle suction.

The depressurizing pump 134 may be configured to depressurize the inside of the holder 127. In one example, the depressurizing pump 134 depressurizes the inside of the holder 127 by depressurizing the inside of the buffer 131. The depressurizing pump 134 depressurizes the inside of the holder 127 through the buffer 131 and the wiper depressurization path 130. The depressurizing pump 134 may be directly connected to the holder 127 or may be directly connected to the wiper depressurization path 130.

The depressurizing unit 128 discharges the liquid from the holder 127 by depressurizing the inside of the holder 127 using the depressurizing pump 134. Since the inside of the holder 127 is always open to the atmosphere, when the depressurizing pump 134 depressurizes the inside of the holder 127, the atmospheric air is drawn into the holder 127. As a result, the liquid is discharged from the holder 127. In one example, first, the depressurizing unit 128 depressurizes the inside of the buffer 131 using the depressurizing pump 134 in a state where the wiper on-off valve 133 is closed. Next, the depressurizing unit 128 opens the wiper on-off valve 133. As a result, the negative pressure in the buffer 131 acts on the inside of the holder 127. In this way, the depressurizing unit 128 discharges the liquid from the holder 127.

The depressurizing unit 128 is not limited to depressurizing the inside of the buffer 131, and may be configured to pressurize the inside of the buffer 131. The depressurizing unit 128 discharges the liquid from the buffer 131 by pressurizing the inside of the buffer 131. In one example, the depressurizing unit 128 includes a depressurization flow path 135 and a pressurization flow path 136. The depressurization flow path 135 is connected to the buffer 131 and the depressurizing pump 134. The pressurization flow path 136 is connected to the buffer 131 and the depressurizing pump 134. The depressurizing pump 134 sucks air through the depressurization flow path 135. The depressurizing pump 134 discharges air to the pressurization flow path 136. Thus, the depressurizing unit 128 can depressurize the inside of the buffer 131 through the depressurization flow path 135. The depressurizing unit 128 can pressurize the inside of the buffer 131 through the pressurization flow path 136.

The depressurizing unit 128 includes a depressurization flow path valve 137 and a pressurization flow path valve 138. The depressurization flow path valve 137 is located on the depressurization flow path 135. The depressurization flow path valve 137 opens and closes the depressurization flow path 135. When the depressurization flow path valve 137 is open, the buffer 131 and the depressurizing pump 134 communicate through the depressurization flow path 135. The pressurization flow path valve 138 is located on the pressurization flow path 136. The pressurization flow path valve 138 opens and closes the pressurization flow path 136. When the pressurization flow path valve 138 is open, the buffer 131 and the depressurizing pump 134 communicate through the pressurization flow path 136.

The depressurizing unit 128 includes a depressurization release path 139 and a pressurization release path 140. The depressurization release path 139 is connected to the depressurization flow path 135. Specifically, on the depressurization flow path 135, the depressurization release path 139 is connected between the depressurizing pump 134 and the depressurization flow path valve 137. Through the depressurization release path 139, the depressurization flow path 135 communicates with the atmosphere. The pressurization release path 140 is connected to the pressurization flow path 136. Specifically, on the pressurization flow path 136, the pressurization release path 140 is connected between the depressurizing pump 134 and the pressurization flow path valve 138. Through the pressurization release path 140, the pressurization flow path 136 communicates with the atmosphere.

The depressurizing unit 128 includes a depressurization relief valve 141 and a pressurization relief valve 142. The depressurization relief valve 141 is located on the depressurization release path 139. The depressurization relief valve 141 opens and closes the depressurization release path 139. When the depressurization relief valve 141 is open, the depressurization flow path 135 is opened to the atmosphere. The pressurization relief valve 142 is located on the pressurization release path 140. The pressurization relief valve 142 opens and closes the pressurization release path 140. When the pressurization relief valve 142 is open, the pressurization flow path 136 is opened to the atmosphere.

The depressurizing unit 128 depressurizes the inside of the buffer 131 through the depressurization flow path 135 by driving the depressurizing pump 134 in a state where the pressurization flow path valve 138 and the depressurization relief valve 141 are closed and where the depressurization flow path valve 137 and the pressurization relief valve 142 are open. The depressurizing unit 128 pressurizes the inside of the buffer 131 through the pressurization flow path 136 by driving the depressurizing pump 134 in a state where the depressurization flow path valve 137 and the pressurization relief valve 142 are closed and where the pressurization flow path valve 138 and the depressurization relief valve 141 are open.

The depressurizing unit 128 includes a discharge flow path 143. The discharge flow path 143 is connected to the buffer 131. The discharge flow path 143 is a flow path through which the liquid discharged from the buffer 131 flows. When the depressurizing pump 134 pressurizes the inside of the buffer 131, the liquid is discharged from the buffer 131 through the discharge flow path 143.

The depressurizing unit 128 includes a discharge valve 144. The discharge valve 144 is located on the discharge flow path 143. The discharge valve 144 opens and closes the discharge flow path 143. By opening the discharge valve 144, the liquid can be discharged from the buffer 131 through the discharge flow path 143.

The maintenance unit 31 includes a maintenance box 145. The maintenance box 145 is connected to the discharge flow path 143. The maintenance box 145 stores the liquid discharged from the buffer 131.

The maintenance box 145 includes a moisture permeable film 146. The moisture permeable film 146 is a film through which the liquid cannot pass but air can pass. The inside of the maintenance box 145 communicates with the atmosphere through the moisture permeable film 146. With the inside of the maintenance box 145 communicating with the atmosphere, the liquid can be discharged from the buffer 131 to the maintenance box 145.

The maintenance box 145 may include an absorbing material 147. The absorbing material 147 is configured to absorb a liquid. The absorbing material 147 is made of, for example, a foam material. With the absorbing material 147 absorbing the liquid, the maintenance box 145 can effectively hold the liquid.

The maintenance unit 31 includes a measurement unit 148. The measurement unit 148 is configured to measure the pressure inside the cap 122. In one example, the measurement unit 148 is connected to the buffer 131. The measurement unit 148 measures the pressure inside the cap 122 through the buffer 131 and the cap depressurization path 129. The measurement unit 148 may be directly connected to the cap 122 or may be directly connected to the cap depressurization path 129. The measurement unit 148 includes, for example, a pressure sensor. The depressurizing unit 128 is controlled based on the pressure measured by the measurement unit 148.

The measurement unit 148 may be configured to measure not only the pressure inside the cap 122 but also the pressure inside the holder 127. In one example, the measurement unit 148 measures the pressure inside the holder 127 through the buffer 131 and the wiper depressurization path 130. The measurement unit 148 may be directly connected to the holder 127 or may be directly connected to the wiper depressurization path 130.

The liquid ejecting device 11 includes a control unit 150. The control unit 150 controls various components of the liquid ejecting device 11. The control unit 150 controls the ejecting unit 21, the pressurizing unit 118, the maintenance unit 31, and the like. The control unit 150 may be composed of one or more processors that execute various processes in accordance with a computer program. The control unit 150 may be configured of one or more dedicated hardware circuits such as an ASIC that executes at least some of the various processes. The control unit 150 may be constituted by a circuit including a combination of a processor and a hardware circuit. The processor includes a CPU, and memories such as a RAM and a ROM. The memory stores program codes or commands configured to cause the CPU to execute processes. The memory, i.e., a computer readable medium, includes any type of readable mediums that are accessible by general-purpose or dedicated computers.

### Control for Liquid Ejecting Device

Next, how the control unit 150 controls the liquid ejecting device 11 will be described.

The control unit 150 controls the liquid ejecting device 11 based on a program code or instruction. The control unit 150 executes the opening/closing inspection. The opening/closing inspection is processing of inspecting whether the atmospheric relief valve 124 operates normally. When the atmospheric relief valve 124 does not operate normally, the liquid may leak out. For example, when the atmospheric relief valve 124 does not operate and remains closed, the liquid is not appropriately discharged from the cap 122, and thus the liquid may leak from the cap 122. The cap 122 receives a large amount of liquid during the cleaning. Therefore, in one example, the control unit 150 executes the opening/closing inspection before the cleaning. When the atmospheric relief valve 124 does not operate and remains open, the suction cleaning cannot be appropriately executed, and thus the ejecting unit 21 may be unmaintainable.

The opening/closing inspection includes an opening inspection and a closing inspection. The opening inspection is an inspection for determining whether the atmospheric relief valve 124 is open. The closing inspection is an inspection for determining whether the atmospheric relief valve 124 is closed. In the opening inspection, the control unit 150 determines whether the atmospheric relief valve 124 is open based on the pressure measured by the measurement unit 148. In the closing inspection, the control unit 150 determines whether the atmospheric relief valve 124 is closed based on the pressure measured by the measurement unit 148. Upon determining that the atmospheric relief valve 124 is open in the opening inspection and that the atmospheric relief valve 124 is closed in the closing inspection, the control unit 150 determines that the atmospheric relief valve 124 is operating normally.

The control unit 150 executes the closing inspection after the opening inspection. In one example, the control unit 150 executes the closing inspection immediately after the opening inspection. The control unit 150 may execute the closing inspection after the opening inspection with an interval therebetween.

In the opening inspection, the control unit 150 performs control to open the atmospheric relief valve 124 in a state where the cap 122 is in contact with the nozzle surface 23. Thereafter, the control unit 150 starts the depressurization by the depressurizing unit 128. When the pressure measured by the measurement unit 148 is equal to or higher than a predetermined value, the control unit 150 determines that the atmospheric relief valve 124 is open. That is, the control unit 150 determines that the inside of the cap 122 is in communication with the atmosphere through the atmospheric release path 123.

In the closing inspection, the control unit 150 performs control to close the atmospheric relief valve 124 in a state where the cap 122 is in contact with the nozzle surface 23, and performs depressurization by the depressurizing unit 128. At this time, the depressurization by the depressurizing unit 128 may be continued from the opening inspection or may be restarted in the closing inspection. When the pressure measured by the measurement unit 148 is equal to or lower than a predetermined value, the control unit 150 determines that the atmospheric relief valve 124 is closed. Thus, the control unit 150 determines that the inside of the cap 122 is sealed.

In the maintenance unit 31, when the cap 122 receives the liquid, the liquid may adhere to the atmospheric release path 123. Therefore, the liquid may remain in the atmospheric release path 123 during the opening/closing inspection. The liquid remaining in the atmospheric release path 123 may affect the pressure measured by the measurement unit 148 in the opening/closing inspection. For example, the liquid remaining in the atmospheric release path 123 hinders the flow of air from the atmospheric release path 123 into the cap 122. In this case, the atmospheric relief valve 124 may be determined to be closed due to the pressure measured by the measurement unit 148 being lower than the predetermined value, even though the atmospheric relief valve 124 is open. In one example, there is a similar risk when the liquid remains in the cap depressurization path 129. The liquid remaining in the cap depressurization path 129 hinders the flow of the liquid and air from the inside of the cap 122 into the buffer 131. Thus, the atmospheric relief valve 124 may be determined to be closed due to the pressure measured by the measurement unit 148 being lower than the predetermined value, even though the atmospheric relief valve 124 is open.

The liquid remaining in the atmospheric release path 123 moves from the atmospheric release path 123 to the cap 122 through the continued depressurization by the depressurizing unit 128. Thus, the liquid is discharged from the atmospheric release path 123 through the continued depressurization by the depressurizing unit 128. When the liquid is discharged from the atmospheric release path 123, the negative pressure in the cap 122 drops, and thus the pressure in the cap 122 rises. Similarly, the liquid remaining in the cap depressurization path 129 moves from the cap depressurization path 129 to the buffer 131 through the continued depressurization by the depressurizing unit 128. Thus, the liquid is discharged from the cap depressurization path 129 through the continued depressurization by the depressurizing unit 128. When the liquid is discharged from the cap depressurization path 129, the negative pressure in the buffer 131 drops, and thus the pressure in the buffer 131 rises. As described above, when the depressurization by the depressurizing unit 128 is continued, the liquid remaining in the atmospheric release path 123, the cap depressurization path 129, and the like is discharged. Accordingly, the measurement unit 148 can appropriately measure the pressure in the cap 122.

In the opening inspection, the control unit 150 determines that the atmospheric relief valve 124 is open when the pressure measured by the measurement unit 148 after the elapse of a predetermined standby time from the start of depressurization by the depressurizing unit 128 is equal to or higher than a first threshold. Accordingly, the control unit 150 can determine whether the atmospheric relief valve 124 is open in a state where the impact of the remaining liquid is reduced.

The first threshold is a possible pressure value obtained when it is expected that no liquid remains in the atmospheric release path 123, the cap depressurization path 129, and the like. For example, the first threshold is a minimum value of the measured pressure obtained when the depressurizing unit 128 performs the depressurization in a state where the atmospheric relief valve 124 is open with no liquid remaining in the atmospheric release path 123, the cap depressurization path 129, and the like. The first threshold may also be regarded as a peak value of the negative pressure obtained when the depressurizing unit 128 depressurizes the inside of the cap 122 with no liquid remaining in the atmospheric release path 123, the cap depressurization path 129, and the like.

The standby time is an expected moving time of the liquid remaining in the atmospheric release path 123, the cap depressurization path 129, and the like. When the remaining liquid starts to move, the pressure measured by the measurement unit 148 starts to rise. Thus, the standby time is longer than the time required for the pressure measured by the measurement unit 148 to reach the minimum value. The standby time can also be regarded as a time longer than a time required for the negative pressure measured by the measurement unit 148 to reach the peak value.

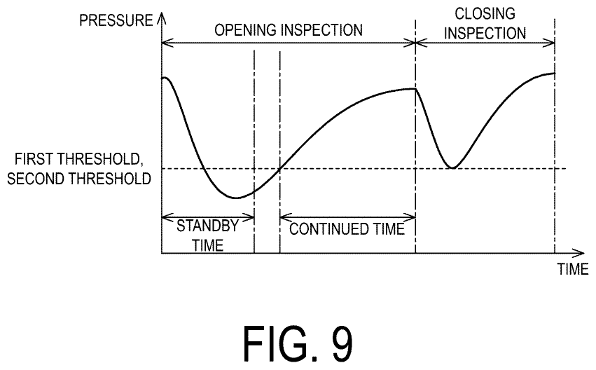

As illustrated in FIG. 9, with the liquid remaining in the atmospheric release path 123, the cap depressurization path 129, and the like in the opening inspection, when depressurization by the depressurizing unit 128 started, the measured pressure starts to drop. When depressurization by the depressurizing unit 128 continues, the measured pressure starts to rise. The measured pressure is at the peak value of the negative pressure immediately before it starts to rise. The time required for the measured pressure to reach the peak value of the negative pressure varies depending on the amount of liquid remaining in the atmospheric release path 123, the cap depressurization path 129, and the like. The larger the amount of the remaining liquid, the longer the time required for the measured pressure to reach the peak value of the negative pressure. The standby time is set to, for example, a time longer than the maximum value of the time required for the measured pressure to reach the peak value of the negative pressure. Thus, it is possible to determine whether the atmospheric relief valve 124 is open based on the measured pressure after exceeding the peak value of the negative pressure, regardless of the amount of liquid remaining in the atmospheric release path 123.

The control unit 150 continues the depressurization by the depressurizing unit 128 even after it is determined that the atmospheric relief valve 124 is open in the opening inspection. Specifically, the control unit 150 continues the depressurization by the depressurizing unit 128 for a continued time after determining that the atmospheric relief valve 124 is open in the opening inspection. As a result, the liquid remaining in the atmospheric release path 123 is discharged together with the liquid remaining in the cap 122. Thus, the next closing inspection can be performed in a state where the impact of the liquid remaining in the atmospheric release path 123 is reduced.

The continued time is a time long enough for the liquid to be discharged from the atmospheric release path 123 and the cap 122. The continued time may be longer or shorter than the standby time. The continued time may be the same as the standby time. The time required to discharge the liquid from the atmospheric release path 123 and the cap 122 varies depending on the amount of liquid remaining in the atmospheric release path 123 and the cap 122. The time increases with the amount of liquid remaining in the atmospheric release path 123 and the cap 122. The continued time is set to, for example, a time longer than the maximum value of the time required to discharge the liquid from the atmospheric release path 123 and the cap 122. Thus, the liquid can be discharged from the atmospheric release path 123 and the cap 122 regardless of the amount of liquid remaining in the atmospheric release path 123 and the cap 122.

When the pressure measured by the measurement unit 148 is equal to or lower than a second threshold in the closing inspection, the control unit 150 determines that the atmospheric relief valve 124 is closed. The control unit 150 can determine whether the atmospheric relief valve 124 is closed in a state where the impact of the remaining liquid is reduced by executing the closing inspection after the opening inspection. Upon determining that the atmospheric relief valve 124 is closed in the closing inspection, the control unit 150 stops the depressurizing unit 128.

The second threshold is a possible pressure value obtained when the inside of the cap 122 is expected to be sealed. For example, the second threshold is a pressure value required for executing the suction cleaning. The second threshold may be the same as or different from the first threshold.

Next, an example of a flowchart of the opening inspection will be described.

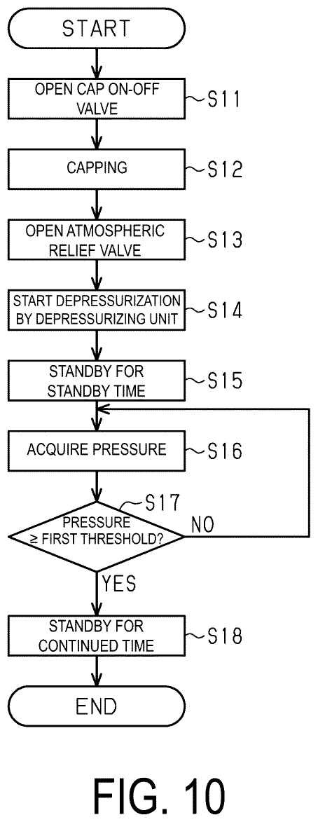

As illustrated in FIG. 10, in step S11, the control unit 150 opens the cap on-off valve 132.

In step S12, the control unit 150 brings the cap 122 into contact with the nozzle surface 23.

The control unit 150 executes an operation of opening the atmospheric relief valve 124 in step S13. In this process, the control unit 150 transmits an opening signal for opening the atmospheric relief valve 124 to the atmospheric relief valve 124.

In step S14, the control unit 150 starts the depressurization by the depressurizing unit 128. In this process, the control unit 150 causes the depressurizing pump 134 to depressurize the inside of the buffer 131.

The control unit 150 stands by for the standby time in step S15. In this process, the depressurization by the depressurizing unit 128 continues for the standby time. As a result, the liquid remaining in the atmospheric release path 123, the cap depressurization path 129, and the like starts to be discharged.

In step S16, the control unit 150 acquires the pressure measured by the measurement unit 148. That is, the control unit 150 acquires the measured pressure in a state where the impact of the remaining liquid is reduced.

In step S17, the control unit 150 determines whether the measured pressure is equal to or higher than the first threshold. When the measured pressure is equal to or higher than the first threshold, the control unit 150 makes the processing proceed to step S18. When the measured pressure is lower than the first threshold, the control unit 150 makes the processing return to step S16. The control unit 150 may issue a notification indicating an error, when the processing does not proceed to step S18 even when the processes in step S16 and step S17 are repeated a plurality of times.

In step S18, the control unit 150 stands by for the continued time. In this process, the depressurization by the depressurizing unit 128 continues for the continued time. Accordingly, the liquid is discharged from the atmospheric release path 123 and the cap 122. Upon ending the process in step S18, the control units 150 ends the opening inspection.

When the closing inspection is performed immediately after the opening inspection, the control unit 150 may continue the depressurization by the depressurizing unit 128. That is, the control unit 150 may make the depressurization by the depressurizing unit 128 which has started in the opening inspection continuously performed in the closing inspection. In this case, the time required for the closing inspection is short compared with the case where the depressurizing unit 128 is stopped between the opening inspection and the closing inspection. When the closing inspection starts after the opening inspection is finished with an interval therebetween, the control unit 150 may finish the depressurization by the depressurizing unit 128 when finishing the opening inspection.

Next, a flowchart of the closing inspection will be described.

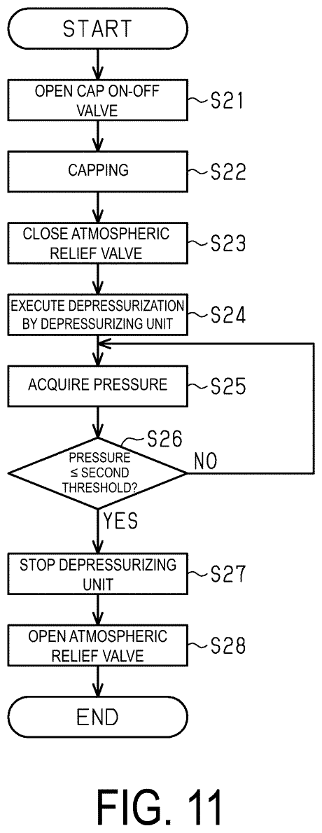

As illustrated in FIG. 11, in step S21, the control unit 150 opens the cap on-off valve 132. When the closing inspection is performed immediately after the opening inspection, the cap on-off valve 132 remains to be open.

In step S22, the control unit 150 brings the cap 122 into contact with the nozzle surface 23. When the closing inspection is performed immediately after the opening inspection, the cap 122 remains in contact with the nozzle surface 23.

In step S23, the control unit 150 performs an operation of closing the atmospheric relief valve 124. In this process, the control unit 150 transmits a closing signal for closing the atmospheric relief valve 124 to the atmospheric relief valve 124.

In step S24, the control unit 150 executes the depressurization by the depressurizing unit 128. In this process, the control unit 150 causes the depressurizing pump 134 to depressurize the inside of the buffer 131. When the closing inspection is executed immediately after the opening inspection, the control unit 150 continues the depressurization of the inside of the cap 122 by the depressurizing unit 128 from step S14. When the closing inspection is executed after the opening inspection with an interval therebetween, the control unit 150 starts the depressurization by the depressurizing unit 128.

In step S25, the control unit 150 acquires the pressure measured by the measurement unit 148.

In step S26, the control unit 150 determines whether the measured pressure is equal to or lower than the second threshold. When the measured pressure is equal to or lower than the second threshold, the control unit 150 makes the processing proceed to step S27. When the measured pressure is higher than the second threshold, the control unit 150 makes the processing return to step S25. The control unit 150 may issue a notification indicating an error, when the processing does not proceed to step S27 even when the processes in step S25 and step S26 are repeated a plurality of times.

In step S27, the control unit 150 stops the depressurizing unit 128.

The control unit 150 executes an operation of opening the atmospheric relief valve 124 in step S28. In this process, the control unit 150 transmits the opening signal to the atmospheric relief valve 124. When the atmospheric relief valve 124 is open, the negative pressure in the cap 122 is released. Upon ending the process in step S28, the control unit 150 ends the closing inspection. When the closing inspection ends, the opening/closing inspection ends.

Next, a wiper inspection will be described.

The control unit 150 may execute the wiper inspection. The wiper inspection is an inspection for determining whether the liquid is normally discharged from the wiper 125. In the maintenance unit 31, when the wiper depressurization path 130 is choked, the liquid may fail to be discharged from the holder 127. For example, the wiper depressurization path 130 is choked when a foreign substance enters the wiper depressurization path 130 or the wiper depressurization path 130 is bent. In this case, the liquid may leak from the holder 127. The wiper inspection may be regarded as an inspection for determining whether the wiper depressurization path 130 is choked.

In the wiper inspection, the control unit 150 executes depressurization by the depressurizing unit 128. In this process, the control unit 150 depressurizes the inside of the holder 127 by depressurizing the inside of the buffer 131. Thereafter, the control unit 150 determines whether the pressure measured by the measurement unit 148 is equal to or lower than a choke threshold. When the measured pressure is equal to or lower than the choke threshold, the control unit 150 determines that the wiper depressurization path 130 is choked. The choke threshold is a measured pressure at which it is expected that liquid will not be normally discharged from the wiper 125. When the measured pressure is equal to or lower than the choke threshold, the control unit 150 determines that the negative pressure does not act in the holder 127.

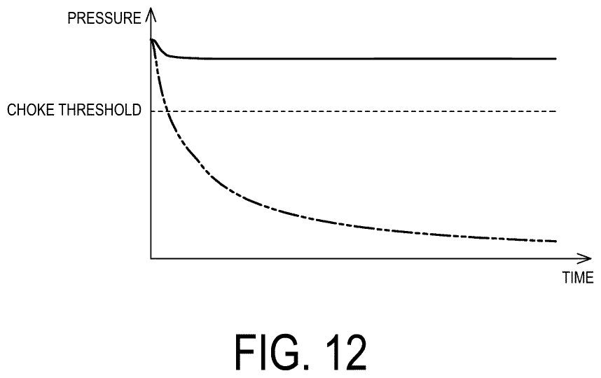

As illustrated in FIG. 12, the pressure measured by the measurement unit 148 when the wiper depressurization path 130 is choked, is lower than that when the wiper depressurization path 130 is not choked. A graph illustrated in a two-dot chain line in FIG. 12 is a pressure measured when the wiper depressurization path 130 is choked. A graph illustrated in a solid line in FIG. 12 is a pressure measured when the wiper depressurization path 130 is not choked.

Next, discharge processing will be described.

The control unit 150 may execute the discharge processing. The discharge processing is processing of discharging a liquid from the buffer 131. The discharge processing may be regarded as processing of making the liquid flow from the buffer 131 to the maintenance box 145. The control unit 150 executes the discharge processing at a predetermined timing. In the discharge processing, the control unit 150 causes the depressurizing unit 128 to pressurize the inside of the buffer 131. In the discharge processing, the control unit 150 controls pressurization by the depressurizing unit 128 based on the pressure measured by the measurement unit 148.

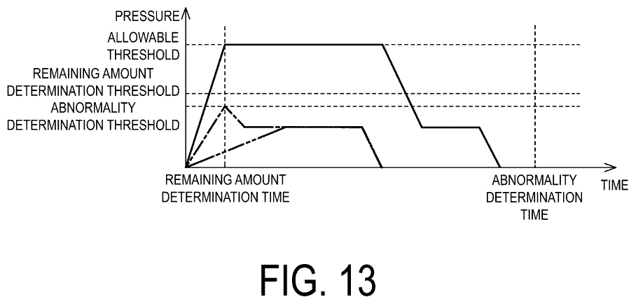

As illustrated in FIG. 13, the control unit 150 pressurizes the inside of the buffer 131 so that the measured pressure does not exceed an allowable threshold in the discharge processing. This is to prevent the pressure in the buffer 131 from exceeding the withstand pressure of the discharge flow path 143, the maintenance box 145, and the like.

In the discharge processing, the control unit 150 determines whether the measured pressure at a remaining amount determination time is equal to or higher than a remaining amount determination threshold. Specifically, the control unit 150 determines whether the measured pressure after the remaining amount determination time has elapsed from the start of pressurization by the depressurizing unit 128 is equal to or higher than the remaining amount determination threshold. When the measured pressure is equal to or higher than the remaining amount determination threshold, the control unit 150 determines that there is the liquid in the buffer 131. When the measured pressure is lower than the remaining amount determination threshold, the control unit 150 determines that there is no liquid in the buffer 131 or that the amount of liquid in the buffer 131 is small. When the liquid is in the buffer 131, the measured pressure is likely to be high as a result of the depressurizing unit 128 pressurizing the inside of the buffer 131. Thus, how much the measured pressure rises varies depending on the presence or absence of the liquid in the buffer 131. Therefore, the control unit 150 can determine whether there is the liquid in the buffer 131 based on the remaining amount determination threshold.

A graph illustrated in a solid line in FIG. 13 indicates a transition in a case where the measured pressure at the remaining amount determination time is equal to or higher than the remaining amount determination threshold. Graphs illustrated in one dot chain line and a two-dot chain line in FIG. 13 indicate a transition in a case where the measured pressure at the remaining amount determination time is lower than the remaining amount determination threshold. The graph illustrated in one dot chain line in FIG. 13 indicates a transition in a case where a small amount of liquid is in the buffer 131. The graph illustrated in a two-dot chain line in FIG. 13 indicates a transition in a case where no liquid is in the buffer 131.

Upon determining that there is no liquid in the buffer 131 or the amount of liquid in the buffer 131 is small, the control unit 150 continues pressurization by the depressurizing unit 128 for a certain period of time and then stops the depressurizing unit 128. Subsequently, the control unit 150 ends the discharge processing.

Upon determining that the liquid is in the buffer 131, the control unit 150 discharges the liquid from the buffer 131. Specifically, the control unit 150 pressurizes the inside of the buffer 131 until the measured pressure falls below an abnormality determination threshold. When the liquid is discharged by pressurizing the buffer 131, the measured pressure drops as the liquid is discharged. When the measured pressure falls below the abnormality determination threshold, the control unit 150 determines that the liquid is normally discharged.

Upon determining that there is a liquid in the buffer 131 and when the measured pressure at the abnormality determination time is equal to or higher than the abnormality determination threshold, the control unit 150 determines that the liquid is not normally discharged. In this case, the control unit 150 executes a cause determination inspection.

The cause determination inspection is an inspection for determining a cause of the failure to discharge the liquid normally. In the maintenance unit 31, when an abnormality occurs in the discharge flow path 143 or the maintenance box 145, the liquid may be unable to be discharged from the buffer 131. When the discharge flow path 143 is choked, the liquid cannot be discharged from the inside of the buffer 131 to the maintenance box 145. When the moisture permeable film 146 is wet with the liquid, the liquid cannot be discharged from the inside of the buffer 131 to the maintenance box 145. The cause determination inspection can be regarded as an inspection for determining which of the discharge flow path 143 and the maintenance box 145 has an abnormality.

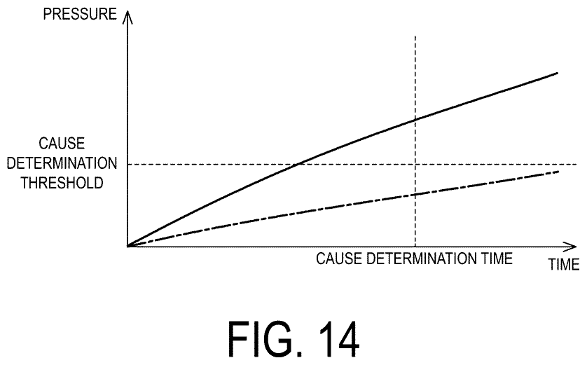

As illustrated in FIG. 14, the control unit 150 pressurizes the inside of the buffer 131 in the cause determination inspection. Thereafter, the control unit 150 determines whether the measured pressure at a cause determination time is equal to or higher than a cause determination threshold. Specifically, the control unit 150 determines whether the measured pressure after the cause determination time has elapsed since the start of the pressurization of the inside of the buffer 131 is equal to or higher than the cause determination threshold. When the measured pressure is equal to or higher than the cause determination threshold, the control unit 150 determines that an abnormality has occurred in the discharge flow path 143. When the measured pressure is lower than the cause determination threshold, the control unit 150 determines that an abnormality has occurred in the maintenance box 145.

The graph illustrated in a solid line in FIG. 14 indicates a transition in a case where an abnormality is occurring in the discharge flow path 143. In FIG. 14, a graph illustrated in a one dot chain line indicates a transition in a case where an abnormality is occurring in the maintenance box 145. In a case where there is an abnormality in the discharge flow path 143, the pressure in the buffer 131 is likely to be high compared with a case where there is an abnormality in the maintenance box 145. This is because it is more difficult for liquid and air to flow from the inside of the buffer 131 to the inside of the maintenance box 145 in a case where an abnormality is occurring in the discharge flow path 143 than in a case where an abnormality is occurring in the maintenance box 145.

The control unit 150 may issue a notification indicating the cause of the discharge failure. This enables the user to recognize whether the discharge flow path 143 needs to be replaced or the maintenance box 145 needs to be replaced.

Operations and Effects Next, operations and effects of the above-mentioned examples are described.

(1) The joining member 42 includes the protruding portion 44 extending inward from the circumference wall 38. According to the above-described configuration, the possibility that the liquid creeps up the joining member 42 is reduced by the protruding portion 44. Therefore, the possibility of the liquid leaking from the receiving unit 36 is reduced.

(2) The reception port 39 opens in the inclined direction D2 inclined with respect to the horizontal direction and the vertical direction. According to the above-described configuration, the accumulation of the liquid in the lower portion of the receiving unit 36 is facilitated.

(3) The lead-out portion 51 is located in a lower portion of the receiving unit 36. According to the above-described configuration, the liquid accumulated in the lower portion of the receiving unit 36 can be efficiently led out through the lead-out portion 51.

(4) A portion of the joining member 42 that comes into contact with the joining surface 41 is made of a material that is the same as the material of the joining surface 41. According to the above-described configuration, the joining strength between the receiving unit 36 and the joining member 42 can be guaranteed.

(5) The joining surface 41 absorbs a laser beam. The joining member 42 transmits the laser beam. According to the above-described configuration, the receiving unit 36 and the joining member 42 can be joined to each other by laser welding. Thus, the joining strength between the receiving unit 36 and the joining member 42 can be guaranteed.

(6) In the reception port 39, the area of the portion not overlapping the joining member 42 is larger than the area of the portion overlapping the joining member 42. According to the above-described configuration, evaporation of the liquid stored in the receiving unit 36 is facilitated.

(7) As viewed in the inclined direction D2, the joining member 42 includes the extending portion 48 extending between the nozzle arrays 25 at the start position P2. When the nozzle array 25 and the joining member 42 overlap, the liquid is likely to adhere to the joining member 42. According to the above-described configuration, since the portion of the joining member 42 overlapping the nozzle array 25 is reduced, the possibility that the liquid adheres to the joining member 42 is reduced. In particular, in the example described above, since the nozzle surface 23 is inclined, the liquid is likely to be accumulated in the lower portion of the nozzle array 25. Therefore, the possibility that the liquid adheres to the joining member 42 is further reduced by the extending portion 48 extending in the portion located in the lower region A2 between the nozzle arrays 25.

(8) The maintenance unit 31 includes the connection portion 53 which is connected to the lead-out portion 51 when the wiping unit 32 is positioned at the standby position P1, and the suction unit 55 which sucks the liquid in the receiving unit 36 through the connection portion 53. According to the above-described configuration, the liquid received by the receiving unit 36 can be effectively led out by the suction unit 55.

(9) The control method for the liquid ejecting device 11 includes executing the opening inspection. The opening inspection includes starting depressurization of the inside of the cap 122 by the depressurizing unit 128 after executing control for opening the atmospheric relief valve 124 in a state where the cap 122 is in contact with the nozzle surface 23, and determining that the atmospheric relief valve 124 is open when the pressure measured by the measurement unit 148 after a predetermined standby time has elapsed after the start of the depressurization by the depressurizing unit 128 is equal to or higher than the first threshold. When the depressurizing unit 128 depressurizes the inside of the cap 122 in a state where the cap 122 is in contact with the nozzle surface 23 and where the atmospheric relief valve 124 is open, air flows into the cap 122 through the atmospheric release path 123. At this time, if the liquid remains in the atmospheric release path 123, the flow of air into the cap 122 is hindered. That is, when the liquid remains in the atmospheric release path 123, the negative pressure in the cap 122 rises due to the depressurization by the depressurizing unit 128. Therefore, even though the atmospheric relief valve 124 is open, it may be determined that the atmospheric relief valve 124 is closed due to the high negative pressure in the cap 122. According to the above-described method, the liquid remaining in the atmospheric release path 123 is sucked by continuing the depressurization by the depressurizing unit 128 over the standby time. Therefore, the negative pressure in the cap 122 drops when the standby time elapses from the start of depressurization by the depressurizing unit 128. That is, the pressure in the cap 122 can be measured in a state where the impact of the liquid remaining in the atmospheric release path 123 is reduced as a result of the elapse of the standby time from the start of depressurization by the depressurizing unit 128. Thus, the atmospheric relief valve 124 can be appropriately inspected.

(10) The method for controlling the liquid ejecting device 11 includes continuing the depressurization by the depressurizing unit 128 even after the atmospheric relief valve 124 is determined to be open in the opening inspection. According to the above-described method, the discharge of the liquid remaining in the atmospheric release path 123 is facilitated.

(11) The method of controlling the liquid ejecting device 11 includes continuing the depressurization by the depressurizing unit 128 for a predetermined continued time after the atmospheric relief valve 124 is determined to be open in the opening inspection. According to the above-described method, the liquid remaining in the cap 122 can be discharged together with the liquid remaining in the atmospheric release path 123.

(12) The method for controlling the liquid ejecting device 11 includes executing the closing inspection after the opening inspection. The closing inspection includes performing control to close the atmospheric relief valve 124 in a state where the cap 122 is in contact with the nozzle surface 23 and performing the depressurization of the inside of the cap 122 by the depressurizing unit 128, and determining that the atmospheric relief valve 124 is closed when the measured pressure is equal to or lower than the second threshold. According to the above-described method, since the closing inspection is performed after the opening inspection, the pressure in the cap 122 can be measured in a state where the impact of the liquid remaining in the atmospheric release path 123 is reduced. Thus, the atmospheric relief valve 124 can be appropriately inspected.

(13) The method for controlling the liquid ejecting device 11 includes executing the closing inspection immediately after the opening inspection. The method for controlling the liquid ejecting device 11 includes continuing in the closing inspection, the depressurization by the depressurizing unit 128 which has started in the opening inspection. According to the above-described configuration, the time required for the closing inspection can be made short compared with the case where the depressurizing unit 128 is stopped between the opening inspection and the closing inspection.

### Modifications

The above-mentioned examples may be modified as follows for implementation. The above-mentioned examples and the following modifications may be combined for implementation insofar as they are not technically inconsistent.
The liquid receiving device 35 is not limited to the wiping unit 32, and may be applied to a flushing receiver, the waste liquid accommodation unit 56, or the like. The liquid receiving device 35 may be applied to a marginless liquid receiver used in marginless printing.
The lead-out portion 51 is not limited to a configuration directly communicating with the inside of the receiving unit 36. For example, in the liquid receiving device 35, the receiving unit 36 and the joining member 42 may be joined to each other to form a flow path establishing communication between the inside of the receiving unit 36 and the lead-out portion 51. In this case, the lead-out portion 51 communicates with the inside of the receiving unit 36 through the flow path.
The liquid ejected from the ejecting unit 21 is not limited to ink, but may be a liquid member in which particles of functional materials are dispersed or mixed in a liquid or the like, for example. For example, the ejecting unit 21 may eject a liquid member in which materials such as electrode materials or pixel materials used for manufacturing liquid crystal displays, electroluminescence displays and surface-emitting displays are dispersed or dissolved.
The opening inspection, the closing inspection, the wiper inspection, the discharge processing, and the cause determination inspection may be executed by a control device such as a computer connected to the liquid ejecting device 11.
The liquid ejected from the ejecting unit 21 is not limited to ink, but may be a liquid member in which particles of functional materials are dispersed or mixed in a liquid or the like, for example. For example, the ejecting unit 21 may eject a liquid member in which materials such as electrode materials or pixel materials used for manufacturing liquid crystal displays, electroluminescence displays and surface-emitting displays are dispersed or dissolved.

### Technical Ideas

The following describes technical ideas and operational effects that are derived from the above-described examples and modifications.

(A) A liquid receiving device includes a receiving unit configured to receive a liquid from an ejecting unit configured to eject the liquid, and a joining member joined to the receiving unit, wherein the receiving unit includes a reception wall configured to receive the liquid, and a circumference wall extending from the reception wall, the circumference wall defines a reception port through which the liquid discharged from the ejecting unit passes, and includes a joining surface joined to the joining member, and the joining member extends along the circumference wall, and includes a protruding portion extending inward from the circumference wall. According to the above-described configuration, the possibility that the liquid creeps up the joining member is reduced by the protruding portion. Therefore, the possibility of the liquid leaking from the receiving unit is reduced.

(B) In the liquid receiving device, the reception port may open in an inclined direction inclined with respect to a horizontal direction and a vertical direction. According to the above-described configuration, the accumulation of the liquid in the lower portion of the receiving unit is facilitated.

(C) The liquid receiving device may further include a lead-out portion through which the liquid is led out from the receiving unit, and the lead-out portion may be positioned in a lower portion of the receiving unit. According to the above-described configuration, the liquid accumulated in the lower portion of the receiving unit can be efficiently led out through the lead-out portion.

(D) In the liquid receiving device, a portion of the joining member that comes into contact with the joining surface may be made of a material that is same as a material of the joining surface. According to the above-described configuration, the joining strength between the receiving unit and the joining member can be guaranteed.

(E) In the liquid ejecting device, the joining surface may absorb a laser beam, and the joining member may transmit the laser beam. According to the above-described configuration, the receiving unit and the joining member can be joined to each other by laser welding. Thus, the joining strength between the receiving unit and the joining member can be guaranteed.

(F) In the liquid receiving device, in the reception port, an area of a portion that does not overlap the joining member may be larger than an area of a portion that overlaps the joining member. According to the above-described configuration, evaporation of the liquid stored in the receiving unit is facilitated.

(G) A liquid ejecting device includes an ejecting unit that includes a nozzle surface in which a nozzle opens and is configured to eject a liquid from the nozzle, and a wiping unit configured to wipe the nozzle surface, wherein the wiping unit includes a blade that comes into contact with the nozzle surface, a receiving unit configured to support the blade, and a joining member joined to the receiving unit, the receiving unit includes a reception wall configured to receive the liquid and a circumference wall extending from the reception wall, the circumference wall defines a reception port through which the liquid discharged from the ejecting unit passes, and includes a joining surface joined to the joining member, the blade extends in a protruding manner from the reception port, and the joining member extends along the circumference wall, and includes a protruding portion extending inward from the circumference wall. According to the above-described configuration, the possibility that the liquid creeps up the joining member is reduced by the protruding portion. Therefore, the possibility of the liquid leaking from the receiving unit is reduced.

(H) In the liquid ejecting device, the reception port may open in an inclined direction inclined with respect to a horizontal direction and a vertical direction, and the nozzle surface may face the reception port. According to the above-described configuration, the accumulation of the liquid in the lower portion of the receiving unit is facilitated.

(I) In the liquid ejecting device, the nozzle may be one of a plurality of nozzles, a plurality of nozzle arrays may be formed on the nozzle surface with the plurality of nozzles arranged, the wiping unit may be positioned to overlap the nozzle surface at a position at which the wiping unit starts wiping as viewed in the inclined direction, and the joining member may include an extending portion at which the wiping unit starts the wiping as viewed in the inclined direction, the extending portion extending between the nozzle arrays at the position. When the joining member and the nozzle array overlap, the liquid is likely to adhere to the joining member. According to the according to the above-described configuration, since the portion of the joining member overlapping the nozzle array is reduced by the extending portion, the possibility that the liquid adheres to the joining member is reduced.

(J) In the liquid ejecting device, a portion of the joining member that comes into contact with the joining surface may be made of a material that is same as a material of the joining surface. According to the above-described configuration, the joining strength between the receiving unit and the joining member can be guaranteed.

(K) In the liquid ejecting device, the joining surface may absorb a laser beam, and the joining member may transmit the laser beam. According to the above-described configuration, the receiving unit and the joining member can be joined to each other by laser welding. Thus, the joining strength between the receiving unit and the joining member can be guaranteed.

(L) In the liquid ejecting device, in the reception port, an area of a portion that does not overlap the joining member may be larger than an area of a portion that overlaps the joining member. According to the above-described configuration, evaporation of the liquid stored in the receiving unit is facilitated.

(M) The liquid ejecting device may further include a lead-out portion through which the liquid is led out from the receiving unit, and the lead-out portion may be positioned in a lower portion of the receiving unit. According to the above-described configuration, the liquid accumulated in the lower portion of the receiving unit can be efficiently led out through the lead-out portion.

(N) The liquid ejecting device may further include a connection portion that is connected to the lead-out portion when the wiping unit is located at a predetermined position, and a suction unit configured to suck the liquid inside the receiving unit through the connection portion. According to the above-described configuration, the liquid received by the receiving unit can be effectively led out by the suction unit.

(O) A method of controlling a liquid ejecting device including a nozzle surface in which a nozzle opens, an ejecting unit configured to eject a liquid from the nozzle, a cap configured to cover the nozzle, a depressurizing unit configured to depressurize inside of the cap, a measurement unit configured to measure pressure inside the cap, an atmospheric release path through which the cap communicates with atmosphere, and an atmospheric relief valve configured to open and close the atmospheric release path, includes executing an opening inspection including starting the depressurization by the depressurizing unit after executing control for opening the atmospheric relief valve in a state where the cap is in contact with the nozzle surface, and determining that the atmospheric relief valve is open when a pressure measured by the measurement unit is equal to or higher than a threshold after a predetermined standby time has elapsed after the starting of the depressurization by the depressurizing unit. When the depressurizing unit depressurizes the inside of the cap in a state where the cap is in contact with the nozzle surface and where the atmospheric relief valve is open, air flows into the cap through the atmospheric release path. At this time, if the liquid remains in the atmospheric release path, the flow of air into the cap is hindered. That is, when the liquid remains in the atmospheric release path, the negative pressure inside the cap rises due to the depressurization by the depressurizing unit. Therefore, there is a possibility that it is determined that the atmospheric relief valve is closed because the negative pressure in the cap is large even though the atmospheric relief valve is open. According to the above-described method, the liquid remaining in the atmospheric release path is sucked by continuing the depressurization by the depressurizing unit over the standby time. Therefore, the negative pressure in the cap drops when the standby time elapses from the start of depressurization by the depressurizing unit. That is, the pressure in the cap can be measured in a state where the impact of the liquid remaining in the atmospheric release path is reduced as a result of the elapse of the standby time from the start of depressurization by the depressurizing unit. Thus, the atmospheric relief valve can be appropriately inspected.

(P) The method for controlling the liquid ejecting device may include continuing the depressurization by the depressurizing unit even after the atmospheric relief valve is determined to be open in the opening inspection. According to the above-described method, the discharge of the liquid remaining in the atmospheric release path is facilitated.

(Q) The method for controlling the liquid ejecting device may include continuing the depressurization by the depressurizing unit for a predetermined continued time, after the atmospheric relief valve is determined to be open in the opening inspection. According to the above-described method, the liquid remaining in the cap can be discharged together with the liquid remaining inside the atmospheric release path.

(R) The method for controlling the liquid ejecting device may include performing a closing inspection after the opening inspection, the threshold may be a first threshold, and the closing inspection may include performing control to close the atmospheric relief valve and performing depressurization by the depressurizing unit in a state where the cap is in contact with the nozzle surface, and determining that the atmospheric relief valve is closed when the pressure measured by the measurement unit is equal to or lower than a second threshold. According to the above-described method, since the closing inspection is performed after the opening inspection, the pressure in the cap can be measured in a state where the impact of the liquid remaining in the atmospheric release path is reduced. Thus, the atmospheric relief valve can be appropriately inspected.

(S) The method for controlling the liquid ejecting device may further include performing the closing inspection immediately after the opening inspection, and continuing in the closing inspection, the depressurization by the depressurizing unit that has started in the opening inspection. According to the above-described configuration, the time required for the closing inspection can be made short compared with the case where the depressurizing unit is stopped between the opening inspection and the closing inspection.

(T) A liquid ejecting device includes a nozzle surface in which a nozzle opens, an ejecting unit configured to eject a liquid from the nozzle, a cap configured to cover the nozzle, a depressurizing unit configured to depressurize inside of the cap, a measurement unit configured to measure pressure inside the cap, an atmospheric release path through which the cap communicates with atmosphere, an atmospheric relief valve configured to open and close the atmospheric release path, and a control unit, wherein the control unit performs opening inspection of starting the depressurization by the depressurizing unit after executing control for opening the atmospheric relief valve in a state where the cap is in contact with the nozzle surface, and determining that the atmospheric relief valve is open when a pressure measured by the measurement unit is equal to or higher than a threshold after a predetermined standby time has elapsed after the starting of the depressurization by the depressurizing unit. According to the above-described configuration, effects similar to those in the above-described method can be exerted.

(U) In the liquid ejecting device, the control unit may continue the depressurization by the depressurizing unit even after the atmospheric relief valve is determined to be open in the opening inspection. According to the above-described configuration, effects similar to those in the above-described method can be exerted.

(V) In the liquid ejecting device, the threshold may be a first threshold, and the control unit may perform, after the opening inspection, the closing inspection including performing control to close the atmospheric relief valve and performing depressurization by the depressurizing unit in a state where the cap is in contact with the nozzle surface, and determining that the atmospheric relief valve is closed when the pressure measured by the measurement unit is equal to or lower than a second threshold. According to the above-described configuration, effects similar to those in the above-described method can be exerted.

What is claimed is:

1. A liquid receiving device comprising:
a receiving unit configured to receive a liquid from an ejecting unit configured to eject the liquid; and
a joining member joined to the receiving unit, wherein
the receiving unit includes a reception wall configured to receive the liquid, and a circumference wall extending from the reception wall, wherein
the circumference wall
defines a reception port through which the liquid discharged from the ejecting unit passes, and
includes a joining surface joined to the joining member, and
the joining member
extends along the circumference wall, and
includes a protruding portion extending inward from the circumference wall.

2. The liquid receiving device according to claim 1, wherein the reception port opens in an inclined direction inclined with respect to a horizontal direction and a vertical direction.

3. The liquid receiving device according to claim 2, further comprising a lead-out portion through which the liquid is led out from the receiving unit, wherein
the lead-out portion is positioned in a lower portion of the receiving unit.

4. The liquid receiving device according to claim 1, wherein a portion of the joining member that comes into contact with the joining surface is made of a material that is same as a material of the joining surface.

5. The liquid receiving device according to claim 4, wherein
the joining surface absorbs a laser beam, and
the joining member transmits the laser beam.

6. The liquid receiving device according to claim 1, wherein in the reception port, an area of a portion that does not overlap the joining member is larger than an area of a portion that overlaps the joining member.

7. A liquid ejecting device comprising:
an ejecting unit that includes a nozzle surface in which a nozzle opens and is configured to eject a liquid from the nozzle; and
a wiping unit configured to wipe the nozzle surface, wherein
the wiping unit includes
a blade that comes into contact with the nozzle surface,
a receiving unit configured to support the blade, and
a joining member joined to the receiving unit,
the receiving unit includes
a reception wall configured to receive the liquid, and
a circumference wall extending from the reception wall,
the circumference wall
defines a reception port through which the liquid discharged from the ejecting unit passes, and
includes a joining surface joined to the joining member,
the blade extends in a protruding manner from the reception port, and
the joining member
extends along the circumference wall, and
includes a protruding portion extending inward from the circumference wall.

8. The liquid ejecting device according to claim 7, wherein
the reception port opens in an inclined direction inclined with respect to a horizontal direction and a vertical direction, and
the nozzle surface faces the reception port.

9. The liquid ejecting device according to claim 8, wherein
the nozzle is one of a plurality of nozzles,
a plurality of nozzle arrays are formed on the nozzle surface with the plurality of nozzles arranged,
the wiping unit is positioned to overlap the nozzle surface at a position at which the wiping unit starts wiping as viewed in the inclined direction, and
the joining member includes an extending portion at the position at which the wiping unit starts the wiping as viewed in the inclined direction, the extending portion extending between the nozzle arrays.

10. The liquid ejecting device according to claim 7, wherein a portion of the joining member that comes into contact with the joining surface is made of a material that is same as a material of the joining surface.

11. The liquid ejecting device according to claim 10, wherein
the joining surface absorbs a laser beam, and
the joining member transmits the laser beam.

12. The liquid ejecting device according to claim 7, wherein in the reception port, an area of a portion that does not overlap the joining member is larger than an area of a portion that overlaps the joining member.

13. The liquid ejecting device according to claim 7, further comprising a lead-out portion through which the liquid is led out from the receiving unit, wherein
the lead-out portion is positioned in a lower portion of the receiving unit.

14. The liquid ejecting device according to claim 13, further comprising:
a connection portion that is connected to the lead-out portion when the wiping unit is located at a predetermined position; and
a suction unit configured to suck the liquid inside the receiving unit through the connection portion.
